(19) United States
(12) Patent Application Publication
(10) Pub. No.: US 2016/0165849 A1
(43) Pub. Date: Jun. 16, 2016

(54) Leash Having Length-Adjustable Loop-Shaped Handle Portion and Method of Using Same

(71) Applicant: Brandon L. Lewis, Brockway, PA (US)

(72) Inventor: Brandon L. Lewis, Brockway, PA (US)

(21) Appl. No.: 14/968,779

(22) Filed: Dec. 14, 2015

Related U.S. Application Data
(60) Provisional application No. 62/091,605, filed on Dec. 14, 2014.

(51) Int. Cl. A01K 27/00

(52) U.S. Cl. CPC A01K 27/003

(57) ABSTRACT

A leash and method of securing an animal or person to an object using a leash are disclosed. Embodiments provide a leash that includes a handle portion having a handle portion fastening system, the handle portion being formed in a loop while the handle portion fastening system is releasably secured. The loop has a length which may be adjustable via an adjustment device. The adjustments to the loop length may be made via the adjustment device while the animal or person is secured to the object. Embodiments foster easy and quick restraint of an animal or human to an object without having to disconnect the leash from the animal's or human's collar or harness.

### CROSS REFERENCE TO RELATED APPLICATION(S)

This application claims priority from U.S. Provisional Patent Application. No. 62/091,605, filed on Dec. 14, 2014, which is hereby incorporated herein by reference in its entirety.

### FIELD OF THE INVENTION

Embodiments are in the field of leashes. More particularly, embodiments disclosed herein relate to animal or human leashes that include a length-adjustable loop-shaped handle portion having a handle portion fastening system and methods of using same which, inter alia, foster easy and quick restraint of an animal or human to an object without having to disconnect the leash from the animal's or human's collar or harness.

### BACKGROUND OF THE INVENTION

This disclosure pertains to animal (e.g., dog, cat, pig, horse, etc.) and human leashes. It differs significantly from the disclosure in Anthony U.S. Published Patent Application No. 2012/0255506, issued to Anthony, which has a set size loop-end with a single fastener/leash handle component. Anthony's leash, let alone handle portion of the leash, is not adjustable in length and, as such, is very limited in its use and applications.

Embodiments herein are different than the leash disclosed by Anthony in that the embodiments have a handle portion that can be adjusted in overall length before being fastened into a loop. At a minimum, this adjustment can be manually performed as per FIGS. 1-3. In an embodiment, this invention includes a retractable, spool element (e.g., a retractable strap dispenser) that can be unwound as needed for wrapping around an object such as a tree or other permanent or movable object before at least partially retracting into itself and locking in place for a tighter fit of the strap about that object.

Embodiments are directed to providing a length-adjustable loop-shaped handle portion of a leash utilizing a handle portion fastener system and adjustment device that does not detract from the comfort of the handle portion. A significant advantage and improvement of these embodiments over prior art leashes is that an animal or human does not have to be disconnected from the leash in order to secure the leash to an object.

### SUMMARY OF THE INVENTION

Embodiments are directed to a leash for an animal or human contains a fastener system such as a clasp and hook (or ring) in the looped handle portion of the leash. The length of the handle portion may be made manually adjustable (utilizing, for example, a buckle/belt fastener) or within a self-contained retractable dispenser of strap that can be extended as needed, retracted, and locked into place, and then unlocked for easier disconnect once the securement of the leash to the object is no longer needed.

According to embodiments, the leashes described herein are incredibly easy to use and helpful to most animal owners and/or caretakers. These leashes enable an animal (or human) to easily be restrained/tied to a fixed or movable object (e.g., a tree, pole, table, desk, bench, chair, toilet, building or other structure, fence, street sign, post, bicycle, car, or even another human, etc.) without having to disconnect the leash from the animal's or human's collar or harness. Simply by unsecuring a fastener within the handle portion, the handle portion itself can then be secured to or around an object, and adjusted to the proper length (e.g., circumference, around an object), all while maintaining control and keeping the animal or human leashed at the end opposite the handle portion end of the leash. The adjustment of the length of the handle portion may be performed prior to or subsequent to securing the handle portion to or around the object.

With reference to the Anthony published application mentioned above, if Anthony's handle portion was not large enough to fit around an object (e.g., a tree), a remaining portion of the leash would have been unbuckled from the animal and the remaining portion would itself be used to secure the leash around the object leaving little slack for re-securement of the animal to the leash. At the same time, such re-securement would often result in an improper use of slack that could be very detrimental to the securing of an animal to an object.

### BRIEF DESCRIPTION OF THE DRAWINGS

The detailed description will refer to the following drawings, wherein like reference numerals refer to like elements, and wherein:

FIG. 1 is a diagram illustrating an embodiment of a handle portion and an exemplary adjustment device of a leash, with an exemplary handle portion fastening system of the handle portion releasably secured. The adjustment device includes an adjustment device fastening system which is positioned at an intermediate portion between the handle portion and an elongated main portion of the leash. The handle portion is formed in a loop while the handle portion fastening system is releasably secured;

FIG. 2 is a diagram illustrating the handle portion and adjustment device shown in FIG. 1, with the handle portion fastening system unsecured;

FIG. 3 is a diagram illustrating the handle portion and adjustment device shown in FIG. 1, with the loop having a length which is larger than a length of the loop in FIG. 1;

FIG. 4 is a diagram illustrating another embodiment of a diagram illustrating a handle portion and an exemplary adjustment device of a leash, with an exemplary handle portion fastening system releasably secured. The adjustment device is positioned at or adjacent to an intermediate portion (which is positioned between the handle portion and an elongated main portion of the leash) and/or is positioned along a first strap or a second strap of the handle portion. The handle portion is formed in a loop while the handle portion fastening system is releasably secured;

FIG. 5 is a diagram illustrating the handle portion and adjustment device shown in FIG. 4, with the loop wrapped around a tree trunk; and

FIG. 6 is a flowchart illustrating an embodiment of a method of securing an animal or person to an object using a leash.

### DETAILED DESCRIPTION OF THE INVENTION

It is to be understood that the figures and descriptions of the present invention may have been simplified to illustrate elements that are relevant for a clear understanding of the present invention, while eliminating, for purposes of clarity, other elements found in a typical leash or typical method of securing an animal or human to an object using a leash. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

Embodiments are directed to an animal or human leash that includes a length-adjustable loop-shaped handle portion having a handle portion fastening system and methods of using same. The length adjustability of the loop-shaped handle portion may be performed manually or mechanically.

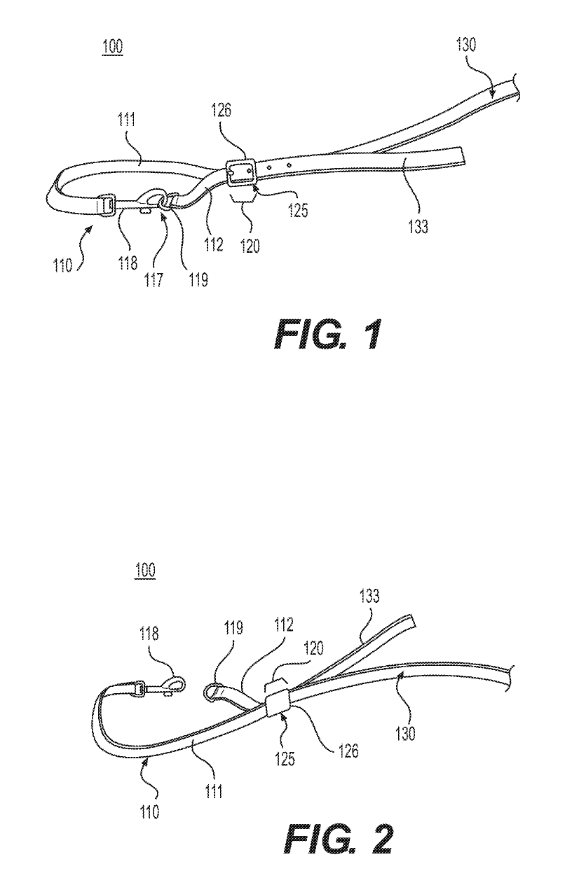

With reference to FIG. 1, shown is a diagram illustrating an embodiment of a handle portion 110 and an exemplary adjustment device 125 of a leash 100, with an exemplary handle portion fastening system 117 of the handle portion 110 releasably secured. The adjustment device 125 includes an adjustment device fastening system 126 (shown in block form in FIGS. 1-3) which is positioned at an intermediate portion 120 between the handle portion 110 and an elongated main portion 130 of the leash 100. The handle portion 110, intermediate portion 120, and/or the elongated main portion 130 may be integral with each other or may be separately connected portions. The handle portion 110 is formed in a loop while the handle portion fastening system 117 is releasably secured. FIG. 2 is a diagram illustrating the handle portion 110 and adjustment device 125 shown in FIG. 1, with the adjustment device fastening system 126 unsecured.

In FIG. 1, a leash 100 having a first end and a second end is provided. The leash includes an elongated main portion 130 which includes a main portion fastening system 238 (FIG. 5) positioned at the first end of the leash 100, wherein the main portion fastening system 238 is configured to be releasably secured to an animal or human/person (not shown) via a collar or harness of (or via directly to) the animal or person for purposes of, for example, walking, exercising, controlling, restraining, guiding, etc. The main portion fastening system 238 may include an item selected from the group consisting of a buckle, D-ring, snap, button, clasp, clip, hook and loop fastener, and combinations thereof. The main portion fastening system 238 may alternatively include a loop that surrounds the animal or person, partly or entirely for securement purposes. The main portion fastening system 238 may allow for easy, safe tethering to, for example, a dog for walking about or exercising.

The leash 100 also includes an intermediate portion 120 and a handle portion 110 extending from the second end of the leash 100 towards the first end of the leash 100, wherein the intermediate portion 120 is positioned between the main portion 130 and the handle portion 110. The handle portion 110 includes a handle portion fastening system 117 at a distance from the intermediate portion 120. Alternatively, handle portion fastening system 117 may be positioned at or adjacent to the intermediate portion 120.

The handle portion fastening system 117 includes a first mating device 118 and a second mating device 119 complementary to the first mating device 118 such that the first mating device 118 is configured to be releasably secured to the second mating device 119. The first mating device 118 and/or the second mating device 119 may include an item selected from the group consisting of a buckle, D-ring, snap, button, clasp, clip, hook and loop fastener, and combinations thereof. The first mating device 118 may be, for example, a clasp while the second mating device 119 may be, for example, a complementary hook or ring that is capable of being mated with the clasp.

The handle portion 110 further includes a first strap 111 terminating at the first mating device 118 and a second strap 112 terminating at the second mating device 119. The handle portion 110 is configured to be formed into a loop when the first mating device 118 is releasably secured to the second mating device 119. The handle portion fastening system 117 may be configured to allow for releasable securement of the loop to or around an object (such as a tree 290 in FIG. 5) prior to or subsequent to the length adjustment to the loop (described below). It is noted that the hook or ring mentioned above may alternatively be provided directly at the intermediate portion (i.e., without second strap 112 therebetween) or at a distance from the intermediate portion via, for example, at an end of second strap 112 as per FIGS. 1-3.

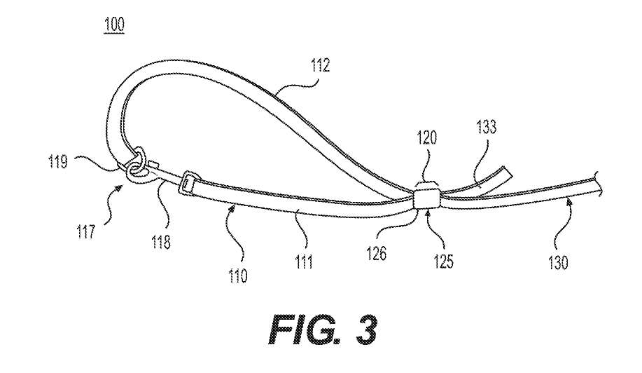

The leash 100 further includes an adjustment device 125 configured to allow for adjustments to a length of the handle portion 110 such that the loop is length-adjustable. FIG. 3 is a diagram illustrating the handle portion and adjustment device shown in FIG. 1, with the loop having a length which is larger than a length of the loop in FIG. 1.

At the handle portion 110, an animal owner, animal walker/controller, or human walker/controller (i.e., when the controlling/restraining/tethering is done to another human) may insert his or her hand or fingers thereof for comfortable walking of the animal or other human. With this improvement (especially over the not-so-easily adjustable earlier variation mentioned above by Anthony's U.S. Published Patent Application No. 2012/0255506), the owner/walker/controller may now further secure his/her animal or other human to a fixed or movable object without ever having to disconnect the leash from the animal's or human's collar or harness. In the case of a fixed object, tethering is possible by people of all abilities and strengths, as now the fixed object does not have to be moved or lifted during the tethering procedure. Current tethering options include a leash permanently fixed to an immovable object such as a backyard tether; a dog run in which one end of the leash is attached to a cable and the opposite end to the dog collar; and disconnecting the leash from the dog collar for wrapping the leash around and about a fixed object, before reconnecting a clasp to a hook end in the same hand component end of the leash/lead.

The adjustment device 125 may include an adjustment device fastening system 126 positioned at the intermediate portion 120, wherein the first strap 111 and the second strap 112 extend from the adjustment device fastening system 126. The adjustment device fastening system 126 is fixedly positioned relative to the first strap 111 (or second strap 112) and is configured to be releasably secured to one of multiple portions along the length of the second strap 112 (or first strap 111) thereby allowing for the adjustability to the length of the loop. The adjustment device fastening system 126 may include an item selected from the group consisting of a buckle, D-ring, snap, button, clip, hook and loop fastener, and combinations thereof.

In an embodiment, adjustment device fastening system 126 may be a strap/belt-sliding adjustment buckle provided and fixed to the intermediate portion 120 of FIGS. 1-3. By feeding more or less hand portion strap through the buckle, the overall length of the wrap around part (i.e., loop) may be manually shortened or extended, respectively. After a loop is wrapped around an object, the loop may be pulled tight or tighter thereafter by manually feeding more strap through the buckle. The excess portion of the strap pulled through the buckle results in excess strap portion 133 as also shown in FIGS. 1-3. This process may be repeated until sufficient slack in the loop around an object (e.g., a tree) is achieved. The buckle may be of any type such as buckle 120 or buckle 225 in U.S. Pat. No. 8,714,114 issued to Wang et al.

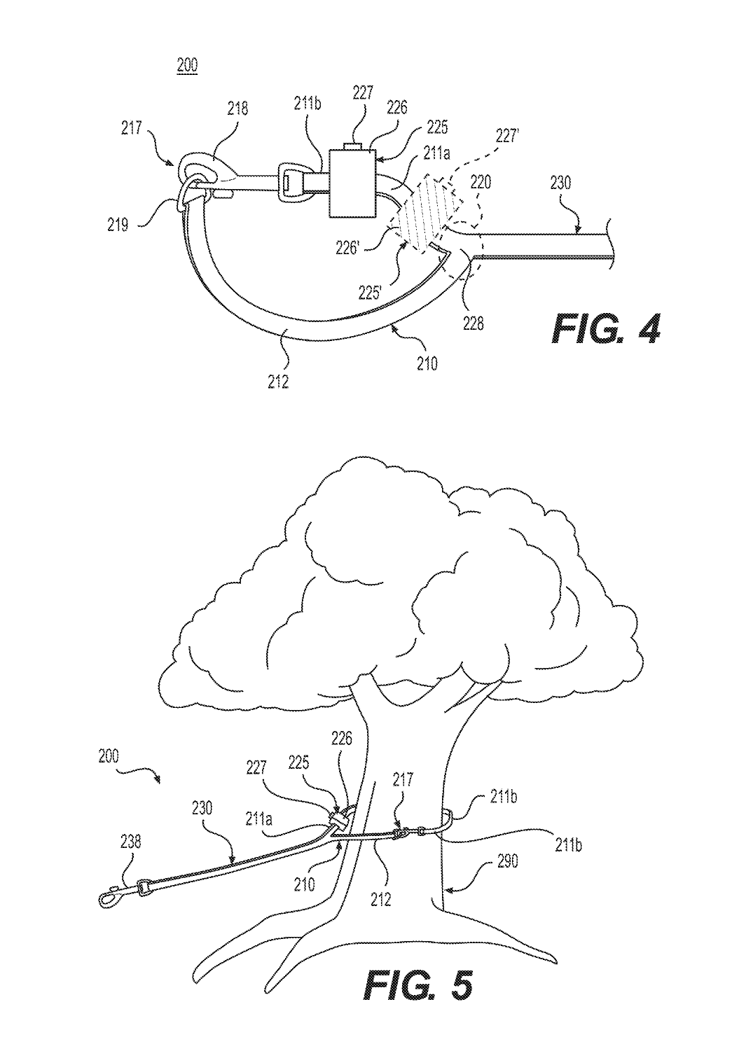

With reference to FIG. 4, shown is a diagram illustrating another embodiment of a handle portion 210 and an exemplary adjustment device 225 (or 225′ shown in phantom) of a leash 200, with an exemplary handle portion fastening system 217 releasably secured. The adjustment device may be positioned at or adjacent to an intermediate portion 220 (which is positioned between the handle portion 210 and an elongated main portion 230 of the leash 200) and/or is positioned along a first strap 211a or a second strap 212 of the handle portion 210. The handle portion 210 is formed in a loop while the handle portion fastening system 217 is releasably secured. FIG. 5 is a diagram illustrating the handle portion 210 and adjustment device 225, 225′ shown in FIG. 4, with the loop wrapped around a trunk of a tree 290.

The adjustment device 225, 225′ may be positioned at or adjacent to the intermediate portion 220 and/or may be positioned along the first strap 211a or the second strap 212. The adjustment device 225, 225′ may be, for example, a retractable strap dispenser 226, 226′ configured to retractably release additional strap 211b in various lengths, the additional strap 211b forming part of the handle portion 210, thereby allowing for the adjustments to the length of the handle portion 210 and the length adjustability of the loop. The retractable strap dispenser 226 may be positioned anywhere along either the first strap 211a or second strap 212 at a distance from the intermediate portion 220. First strap 211a and second strap 212 extend and branch off from intermediate portion 220 at location 228. The retractable strap dispenser 226′ may alternatively be located at or substantially adjacent to the intermediate portion 220 with little or no first strap 211a positioned between the retractable strap dispenser 226′ and the intermediate portion 220.

The retractable strap dispenser 226, 226′ may include a locking system 227, 227′ configured to temporarily lock the additional strap 211b in place when the additional strap 211b is released to a desirable length, thereby allowing for temporary fixation of the length of the loop. The locking system 227, 227′ may be an actuator such as a switch, button, slide, etc. and may keep the additional strap 211b locked in place when the actuator is depressed and later released, requiring another pressing/releasing of the actuator to disengage the release the additional strap 211b. Alternatively, the additional strap 211b may be locked in place only when the actuator is actively depressed. As another alternative, the locking system 227, 227′ may alternatively function in the reverse manner where the additional strap 211b is by default locked in place and is temporarily released only when the actuator is actively depressed.

Retractable strap dispenser 226, 226′ may be a mechanical retracting cartridge through which leash/lead webbing (or other material) forming the additional strap 211b is extended therefrom. The retractable strap dispenser 226, 226′ and locking system 227, 227′ may be, for example, the types used in U.S. Pat. No. 6,148,773 issued to Bogdahn. The locking system in Bogdahn is activated by a “brake key” 9 which may also be employed. A locking mechanism such as the “brake key locking mechanism” 2 in Bogdahn may additionally be employed to lock the locking system 227, 227′ in place (i.e., when the locking system 227, 227′ is of the type that doesn't itself lock in place).

Additional strap 211b may be pulled from the cartridge for fitting around a portion of or an entire tree trunk as needed. Then, by pressing an optional retraction button, the additional strap 211b may be re-spooled for “shrinking” the wrapped-around element (i.e., loop) to a more preferred, more manageable, less slacking size/length. When the pet/animal mounting/tethering/hitching period has ended, that same button (or, alternatively, another button) can be hit once more for releasing a sufficient amount of “extra” webbing (thereby lengthening additional strap 211b) to safely, yet comfortably free the leashed animal or human from about the object. Afterwards, the extra “slack” for releasing may be re-refracted back into the cartridge for comfortable storage until it is needed the next time. FIGS. 4 and 5 show the retractable strap dispenser 226 extending from one end of a split handle portion which includes strap 211a. The retractable cartridge/box may lock in place and/or release extra strap therefrom for expanding the range about which the handle portion may be extended for wrapping about a larger/thicker object such as a tree trunk as shown in FIG. 5.

The handle portion fastening system 217 includes a first mating device 218 and a second mating device 219 complementary to the first mating device 218 such that the first mating device 218 is configured to be releasably secured to the second mating device 219. The first mating device 218 and/or the second mating device 219 may include an item selected from the group consisting of a buckle, D-ring, snap, button, clasp, clip, hook and loop fastener, and combinations thereof.

In an embodiment, the first mating device 218 may be a clasp and the second mating device 219 may be a hook or ring that is capable of being mated with the clasp. The handle portion fastening system 217 may be configured to allow for releasable securement of the loop to or around an object (such as tree 290 in FIG. 5) prior to or subsequent to the length adjustment to the loop.

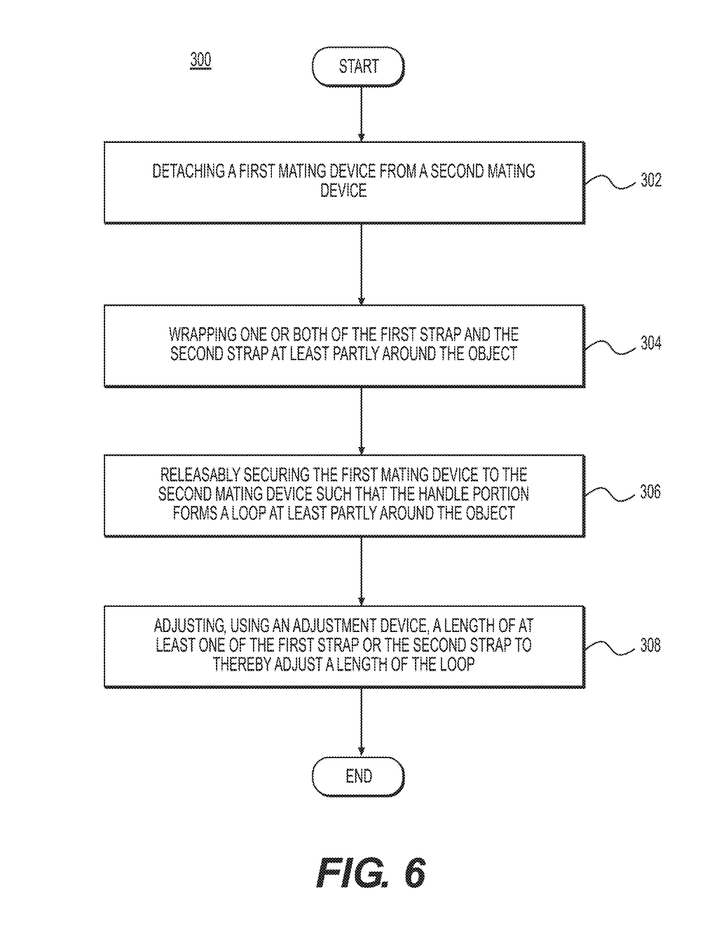

With reference to FIG. 6, shown is a flowchart illustrating another embodiment of a method 300 of securing an animal or person to an object using a leash. The method 300 of securing an animal or person to an object using a leash having a first end and a second end is provided. The method includes: detaching a first mating device from a second mating device (block 302), wherein the first mating device and the second mating device are included in a handle portion of the leash and wherein the handle portion includes a first strap terminating at the first mating device and a second strap terminating at the second mating device; wrapping one or both of the first strap and the second strap at least partly around the object (block 304); releasably securing the first mating device to the second mating device such that the handle portion forms a loop at least partly around the object (block 306); and adjusting, using an adjustment device, a length of at least one of the first strap or the second strap to thereby adjust a length of the loop (block 308), while the loop is formed at least partly around the object. The steps of detaching, wrapping, releasably securing, and adjusting may all performed while a main portion fastening system of an elongated main portion of the leash is releasably secured to the animal or person, wherein the elongated main portion extends from the first end of the leash towards the second end of the leash, and wherein the handle portion extends from the second end of the leash towards the first end of the leash. The step of releasably securing the first mating device to the second mating device may be performed prior to or subsequent to the step of adjusting.

In an embodiment, the adjustment device includes an adjustment device fastening system positioned at an intermediate portion positioned between the handle portion and the elongated main portion, and wherein the first strap and the second strap extend from the adjustment device fastening system. The adjustment device fastening system may be fixedly positioned relative to the first strap. The method may further include releasably securing the adjustment device fastening system to one of multiple portions along the length of the second strap thereby allowing for the adjustability to the length of the loop. The adjustment device fastening system may include an item selected from the group consisting of a buckle, D-ring, snap, button, clasp, clip, hook and loop fastener, and combinations thereof.

In an embodiment, the adjustment device may be positioned at or adjacent to an intermediate portion positioned between the handle portion and the elongated main portion and/or is positioned along the first strap or the second strap. The adjustment device may be a retractable strap dispenser. The method may further include retractably releasing, using the retractable strap dispenser, additional strap in various lengths, the additional strap forming part of the handle portion, thereby adjusting the length of the handle portion whereby the length of the loop is adjusted. The retractable strap dispenser may include a locking system. The method may further include temporarily locking, using the locking system, the additional strap in place when the additional strap is released to a desirable length, thereby temporarily fixing the length of the loop.

Without any of the embodiments described above, it is quite difficult to tether a connected pet/animal or human, let alone tether a connected pet/animal or human at a moment's notice. Embodiments herein allow the animal owner or animal/human walker to quickly yet safely secure his/her pet/animal (or other human) anywhere the owner/walker desires, with ease. Simply unsecure (e.g., unclasp) the handle portion fastening system located in the handle portion of the leash; and reconnect the clasping end to a fixed hook or ring in the same handle portion. Unlike the prior leash in Anthony's published application mentioned above, the overall loop length of the embodiments above may be manually adjusted (per FIGS. 1-3) or mechanically lengthened and retracted per the webbing cartridge shown in FIGS. 4 and 5. The animal or human is now better secured to a fixed or movable object and some or all slack in the leash removed therefrom without ever having to disconnect and subsequently reconnect the leash to the animal's or human's collar or harness.

In any of the embodiments above, any or all of straps 111, 112, 211a, 212, and even additional strap 211b, may be composed of any suitable flexible material having sufficient tensile strength in order to control, restrain or tether the animal or human to an object without breaking, such as webbing, cord, chain, cable, string, wire, cloth, nylon, leather, or combinations thereof. The main portion and/or intermediate portion may also be composed of similar material.

Although embodiments are described above with reference to a leash being tethered to an animal or human via a collar or harness that is worn by the animal or human, the leash described in any of the above embodiments may alternatively be tethered to the animal or human via other intermediary device or may even be tethered to the animal or human directly, i.e., without an intermediary device, and may therefore utilize the advantages of the configurations and embodiments described above.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

1. A leash having a first end and a second end, the leash comprising:
an elongated main portion comprising a main portion fastening system positioned at the first end of the leash, wherein the main portion fastening system is configured to be releasably secured to an animal or person;
an intermediate portion;
a handle portion extending from the second end of the leash towards the first end of the leash, wherein the intermediate portion is positioned between the main portion and the handle portion, the handle portion comprising a handle portion fastening system at a distance from the intermediate portion, the handle portion fastening system comprising:
a first mating device; and
a second mating device complementary to the first mating device such that the first mating device is configured to be releasably secured to the second mating device, wherein the handle portion further comprises a first strap terminating at the first mating device and a second strap terminating at the second mating device, wherein the handle portion is configured to be formed into a loop when the first mating device is releasably secured to the second mating device; and
an adjustment device configured to allow for adjustments to a length of the handle portion such that the loop is length-adjustable.

2. The leash of claim 1, wherein the adjustment device comprises an adjustment device fastening system positioned at the intermediate portion, and wherein the first strap and the second strap extend from the adjustment device fastening system.

3. The leash of claim 2, wherein the adjustment device fastening system is fixedly positioned relative to the first strap and is configured to be releasably secured to one of multiple portions along the length of the second strap thereby allowing for the adjustability to the length of the loop.

4. The leash of claim 3, wherein the adjustment device fastening system comprises an item selected from the group consisting of a buckle, D-ring, snap, button, clasp, clip, hook and loop fastener, and combinations thereof.

5. The leash of claim 2, wherein the first mating device is a clasp and the second mating device is a hook or ring.

6. The leash of claim 2, wherein the handle portion fastening system is configured to allow for releasable securement of the loop to or around an object prior to the length adjustment to the loop.

7. The leash of claim 2, wherein the handle portion fastening system is configured to allow for releasable securement of the loop to or around an object subsequent to the length adjustment to the loop.

8. The leash of claim 1, wherein the adjustment device is positioned at or adjacent to the intermediate portion and/or is positioned along the first strap or the second strap.

9. The leash of claim 8, wherein the adjustment device is a retractable strap dispenser configured to retractably release additional strap in various lengths, the additional strap forming part of the handle portion, thereby allowing for the adjustments to the length of the handle portion and the length adjustability of the loop.

10. The leash of claim 9, wherein the retractable strap dispenser comprises a locking system configured to temporarily lock the additional strap in place when the additional strap is released to a desirable length, thereby allowing for temporary fixation of the length of the loop.

11. The leash of claim 8, wherein the adjustment device is further positioned substantially adjacent to the intermediate portion.

12. The leash of claim 8, wherein the first mating device is a clasp and the second mating device is a hook or ring.

13. The leash of claim 8, wherein the handle portion fastening system is configured to allow for releasable securement of the loop to or around an object prior to the length adjustment to the loop.

14. The leash of claim 8, wherein the handle portion fastening system is configured to allow for releasable securement of the loop to or around an object subsequent to the length adjustment to the loop.

15. A method of securing an animal or person to an object using a leash having a first end and a second end, the leash comprising an elongated main portion comprising a main portion fastening system positioned at the first end of the leash, the main portion fastening system configured to be releasably secured to the animal or person, the leash further comprising a handle portion and an intermediate portion positioned between the main portion and the handle portion, the handle portion extending from the second end of the leash towards the first end of the leash, the method comprising:
detaching a first mating device from a second mating device, wherein the first mating device and the second mating device are included in the handle portion and are positioned at a distance from the intermediate portion, and wherein the handle portion comprises a first strap terminating at the first mating device and a second strap terminating at the second mating device;
wrapping one or both of the first strap and the second strap at least partly around the object;
releasably securing the first mating device to the second mating device such that the handle portion forms a loop at least partly around the object; and
adjusting, using an adjustment device, a length of at least one of the first strap or the second strap to thereby adjust a length of the loop, while the loop is formed at least partly around the object.

16. The method of claim 15, wherein the adjustment device comprises an adjustment device fastening system positioned at the intermediate portion, and wherein the first strap and the second strap extend from the adjustment device fastening system.

17. The method of claim 16, wherein the adjustment device fastening system is fixedly positioned relative to the first strap, the method further comprising releasably securing the adjustment device fastening system to one of multiple portions along the length of the second strap thereby allowing for the adjustability to the length of the loop.

18. The method of claim 17, wherein the adjustment device fastening system comprises an item selected from the group consisting of a buckle, D-ring, snap, button, clasp, clip, hook and loop fastener, and combinations thereof.

19. The method of claim 16, wherein the first mating device is a clasp and the second mating device is a hook or ring.

20. The method of claim 16, wherein the step of releasably securing the first mating device to the second mating device is performed prior to the step of adjusting.

21. The method of claim 16, wherein the step of releasably securing the first mating device to the second mating device is performed subsequent to the step of adjusting.

22. The method of claim 16, wherein the steps of detaching, wrapping, releasably securing, and adjusting are all performed while the main portion fastening system is releasably secured to the animal or person.

23. The method of claim 15, wherein the adjustment device is positioned at or adjacent to the intermediate portion and/or is positioned along the first strap or the second strap.

24. The method of claim 23, wherein the adjustment device is a retractable strap dispenser, the method further comprising retractably releasing, using the retractable strap dispenser, additional strap in various lengths, the additional strap forming part of the handle portion, thereby adjusting the length of the handle portion whereby the length of the loop is adjusted.

25. The method of claim 24, wherein the retractable strap dispenser comprises a locking system, the method further comprising temporarily locking, using the locking system, the additional strap in place when the additional strap is released to a desirable length, thereby temporarily fixing the length of the loop.

26. The method of claim 23, wherein the adjustment device is further positioned substantially adjacent to the intermediate portion.

27. The method of claim 23, wherein the first mating device is a clasp and the second mating device is a hook or ring.

28. The method of claim 23, wherein the step of releasably securing the first mating device to the second mating device is performed prior to the step of adjusting.

29. The method of claim 23, wherein the step of releasably securing the first mating device to the second mating device is performed subsequent to the step of adjusting.

30. The method of claim 23, wherein the steps of detaching, wrapping, releasably securing, and adjusting are all performed while the main portion fastening system is releasably secured to the animal or person.

31. A method of securing an animal or person to an object using a leash having a first end and a second end, the method comprising:
detaching a first mating device from a second mating device, wherein the first mating device and the second mating device are included in a handle portion of the leash and wherein the handle portion comprises a first strap terminating at the first mating device and a second strap terminating at the second mating device;
wrapping one or both of the first strap and the second strap at least partly around the object;
releasably securing the first mating device to the second mating device such that the handle portion forms a loop at least partly around the object; and
adjusting, using an adjustment device, a length of at least one of the first strap or the second strap to thereby adjust a length of the loop, while the loop is formed at least partly around the object.

32. The method of claim 31, wherein the steps of detaching, wrapping, releasably securing, and adjusting are all performed while a main portion fastening system of an elongated main portion of the leash is releasably secured to the animal or person, wherein the elongated main portion extends from the first end of the leash towards the second end of the leash, and wherein the handle portion extends from the second end of the leash towards the first end of the leash.

33. The method of claim 32, wherein the adjustment device comprises an adjustment device fastening system positioned at an intermediate portion positioned between the handle portion and the elongated main portion, and wherein the first strap and the second strap extend from the adjustment device fastening system.

34. The method of claim 33, wherein the adjustment device fastening system is fixedly positioned relative to the first strap, the method further comprising releasably securing the adjustment device fastening system to one of multiple portions along the length of the second strap thereby allowing for the adjustability to the length of the loop.

35. The method of claim 34, wherein the adjustment device fastening system comprises an item selected from the group consisting of a buckle, D-ring, snap, button, clasp, clip, hook and loop fastener, and combinations thereof.

36. The method of claim 32, wherein the adjustment device is positioned at or adjacent to an intermediate portion positioned between the handle portion and the elongated main portion and/or is positioned along the first strap or the second strap.

37. The method of claim 36, wherein the adjustment device is a retractable strap dispenser, the method further comprising retractably releasing, using the retractable strap dispenser, additional strap in various lengths, the additional strap forming part of the handle portion, thereby adjusting the length of the handle portion whereby the length of the loop is adjusted.

38. The method of claim 37, wherein the retractable strap dispenser comprises a locking system, the method further comprising temporarily locking, using the locking system, the additional strap in place when the additional strap is released to a desirable length, thereby temporarily fixing the length of the loop.

39. The method of claim 36, wherein the adjustment device is further positioned substantially adjacent to the intermediate portion.

40. The method of claim 31, wherein the first mating device is a clasp and the second mating device is a hook or ring.

41. The method of claim 31, wherein the step of releasably securing the first mating device to the second mating device is performed prior to the step of adjusting.

42. The method of claim 31, wherein the step of releasably securing the first mating device to the second mating device is performed subsequent to the step of adjusting.
